(19) United States
(12) Patent Application Publication
(10) Pub. No.: US 2025/0076515 A1
(43) Pub. Date: Mar. 6, 2025

(54) VEHICLE POSITIONING SYSTEM AND STORAGE MEDIUM STORING VEHICLE INFORMATION PROVISION PROGRAM

(71) Applicant: DENSO CORPORATION, Kariya-city (JP)

(72) Inventor: Shin YOSHIZAWA, Kariya-city (JP)

(21) Appl. No.: 18/951,082

(22) Filed: Nov. 18, 2024

Related U.S. Application Data
(63) Continuation of application No. PCT/JP2023/022953, filed on Jun. 21, 2023.

(30) Foreign Application Priority Data
Jul. 21, 2022 (JP) 2022-116478

(51) Int. Cl. G01S 19/07; H04W 4/46

(52) U.S. Cl. CPC G01S 19/07; H04W 4/46

(57) ABSTRACT

A vehicle positioning system includes a first-vehicle information receiving unit, a surrounding information analysis unit, a positioning unit, a positioning accuracy determination unit, a second-vehicle information generation unit, and a second-vehicle information transmitting unit. The first-vehicle information receiving unit receives first-vehicle information from a first vehicle around a second vehicle. The surrounding information analysis unit analyzes the first-vehicle information to acquire a first positioning performance. The positioning unit performs positioning of the second vehicle based on satellite information and the first positioning performance. The positioning accuracy determination unit determines accuracy of the positioning of the second vehicle. The second-vehicle information generation unit generates second-vehicle information including at least one of information indicating which satellite is used or not used for the positioning, ephemeris information, or pseudorange correction information. The second-vehicle information transmitting unit transmits the second-vehicle information to the first vehicle.

### CROSS REFERENCE TO RELATED APPLICATION

The present application is a continuation application of International Patent Application No. PCT/JP2023/022953 filed on Jun. 21, 2023, which designated the U.S. and claims the benefit of priority from Japanese Patent Application No. 2022-116478 filed on Jul. 21, 2022. The entire disclosures of all of the above applications are incorporated herein by reference.

### TECHNICAL FIELD

This disclosure relates to a vehicle positioning system and a storage medium storing vehicle information provision program.

### BACKGROUND

In an infrastructure cooperation system, it is important to share a vehicle position of one vehicle with other vehicles.

### SUMMARY

According to one aspect of the present disclosure, a first-vehicle information receiving unit is configured to receive first-vehicle information transmitted by a first vehicle around a second vehicle. A surrounding information analysis unit is configured to analyze the first-vehicle information to acquire a first positioning performance of the first vehicle. A positioning unit is configured to perform positioning of the second vehicle based on satellite information acquired by the second vehicle and the first positioning performance. A positioning accuracy determination unit is configured to determine accuracy of the positioning of the second vehicle based on the first positioning performance and second positioning performance of the second vehicle. A second-vehicle information generation unit is configured to generate second-vehicle information based on a determination result by the positioning accuracy determination unit. The second-vehicle information includes at least one of information indicating which satellite is used for the positioning of the second vehicle, information indicating which satellite is not used for the positioning of the second vehicle, ephemeris information, or pseudorange correction information. A second-vehicle information transmitting unit is configured to transmit the second-vehicle information to the first vehicle.

### BRIEF DESCRIPTION OF THE DRAWINGS

The above-described object and other objects, features and advantages of the present disclosure will become more apparent from the following detailed description with reference to the accompanying drawings. In the drawings:

FIG. 1 is a block diagram showing an embodiment of the present disclosure;

FIG. 2 is a diagram showing messages;

FIG. 3 is a diagram showing a pattern of a relationship between positioning accuracy of own vehicle and the number of satellites used;

FIG. 4 is a diagram showing a mode when the positioning accuracy of the own vehicle is poor and the number of satellites used is large;

FIG. 5 is a diagram showing a mode when the positioning accuracy of the own vehicle is poor and the number of satellites used is small;

FIG. 6 is a diagram showing the mode when the positioning accuracy of the own vehicle is better and the number of satellites used is large;

FIG. 7 is a diagram showing the mode when the positioning accuracy of the vehicle is better and the number of satellites used is small;

FIG. 8 is a flowchart showing an other-vehicle information receiving process;

FIG. 9 is a flowchart showing a positioning process; and

FIG. 10 is a flowchart showing an own-vehicle information transmitting process.

### DETAILED DESCRIPTION OF THE PREFERRED EMBODIMENTS

To begin with, examples of relevant techniques will be described.

In an infrastructure cooperation system, it is important to share a vehicle position indicating the current position of the vehicle with other vehicles around the vehicle. However, the positioning performance of each vehicle varies depending on the performance of the GNS receiver installed in the vehicle and the positioning algorithm. Therefore, no matter how good positioning performance of one vehicle may be, if positioning performances of other vehicles are poor, sufficient service may not be received. For example, a technique for comparing the positioning performance of the own vehicle with that of another vehicle is known.

In the known technique, when the positioning performance of the other vehicle is inferior to the positioning performance of the own vehicle, the own vehicle does not provide effective support information to the other vehicle to enhance the positioning accuracy of the other vehicle. Thus, the positioning accuracy of the entire system including the other vehicle cannot be improved.

The purpose of this disclosure is to improve the positioning accuracy of the entire system including other vehicles around the own vehicle.

According to one aspect of the present disclosure, a first-vehicle information receiving unit is configured to receive first-vehicle information transmitted by a first vehicle around a second vehicle. A surrounding information analysis unit is configured to analyze the first-vehicle information to acquire a first positioning performance of the first vehicle. A positioning unit is configured to perform positioning of the second vehicle based on satellite information acquired by the second vehicle and the first positioning performance. A positioning accuracy determination unit is configured to determine accuracy of the positioning of the second vehicle based on the first positioning performance and second positioning performance of the second vehicle. A second-vehicle information generation unit is configured to generate second-vehicle information based on a determination result by the positioning accuracy determination unit. The second-vehicle information includes at least one of information indicating which satellite is used for the positioning of the second vehicle, information indicating which satellite is not used for the positioning of the second vehicle, ephemeris information, or pseudorange correction information. A second-vehicle information transmitting unit is configured to transmit the second-vehicle information to the first vehicle.

The vehicle positioning system of the present disclosure is configured to analyze the first-vehicle information transmitted by the first vehicle around the second vehicle, acquire the positioning performance of the first vehicle, and perform positioning of the second vehicle based on satellite information acquired by the second vehicle and the positioning performance of the first vehicle. The vehicle positioning system of the present disclosure is further configured to determine a positioning accuracy of the second vehicle based on the second positioning performance and the first positioning performance, generate second-vehicle information based on the determination result, and transmit the generated second-vehicle information to the first vehicle. Thus, the second vehicle information, which is effective for improving the first positioning performance, is provided to the first vehicle when the first positioning performance is inferior to the second positioning performance, thereby improving the positioning accuracy of the entire system including the first vehicle.

Hereinafter, one embodiment of the present disclosure will be described with reference to the drawings. The Global Navigation Satellite System (GNSS) described in this embodiment means the generic name of satellite positioning systems such as Global Positioning System (GPS) of the United States, Quasi-Zenith Satellite System (QZSS) of Japan, GLONASS of Russia, Galileo of the Europe, and BeiDou Navigation Satellite System (BDS) of China.

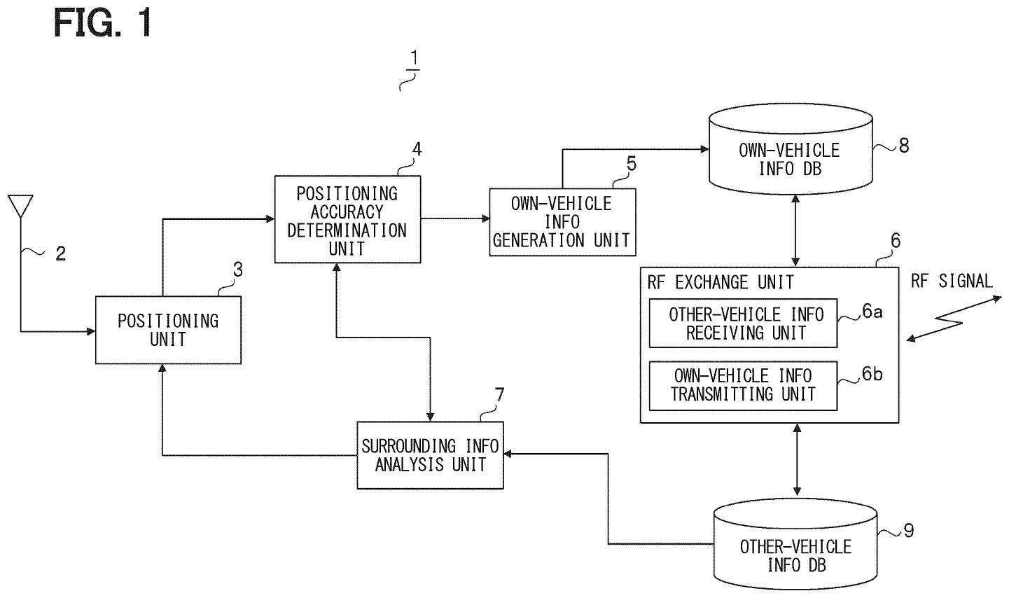

As shown in FIG. 1, a vehicle positioning system 1 installed in a vehicle includes a GNSS antenna 2, a positioning unit 3, a positioning accuracy determination unit 4, an own-vehicle information generation unit 5 (also referred to as a second-vehicle information generation unit 5), an RF exchange unit 6, a surrounding information analysis unit 7, an own-vehicle information database (DB) 8 (also referred to as a second-vehicle information DB 8), and an other-vehicle information database (DB) 9 (also referred to as a first-vehicle information DB 9). Each of these functional blocks 3 to 9 is composed mainly of a microcontroller having elements such as a CPU, a RAM, a ROM, and an I/O port. The microcontroller executes software processing by causing the CPU to execute a computer program stored in a non-transitory tangible storage medium, and executes hardware processing with a dedicated electronic circuit for controlling the vehicle positioning system 1. The computer program executed by the CPU includes an own-vehicle information provision program (also referred to as a second-vehicle information provision program).

The GNSS antenna 2 receives GNSS satellite signals transmitted from the GNSS satellites orbiting in the Earth. The RF exchange unit 6 includes an other-vehicle information receiving unit 6a (also referred to as a first-vehicle information receiving unit 6a) and an own-vehicle information transmitting unit 6b (also referred to as a second-vehicle information transmitting unit 6b). The other-vehicle information receiving unit 6a monitors, at predetermined intervals, whether other-vehicle information transmitted from another vehicle around the own vehicle is received while the ignition switch is on, and the own vehicle is ready to move. The other vehicle is also referred to as a first vehicle and the own vehicle is also referred to as a second vehicle. When the other-vehicle information receiving unit 6a detects receiving of the other-vehicle information transmitted by the other vehicle, the other-vehicle information receiving unit 6a stores the received other-vehicle information in the other-vehicle information DB 9. The other-vehicle information transmitted by the other vehicle includes positioning performance of the vehicle positioning system installed in the other vehicle. The positioning performance of the vehicle positioning system installed in the other vehicle is referred to as first positioning performance.

The surrounding information analysis unit 7 refers to the other-vehicle information DB 9 at predetermined intervals while the ignition switch is on, and the own vehicle is ready to move. When the other-vehicle information DB 9 includes unanalyzed other-vehicle information, the surrounding information analysis unit 7 acquires and analyzes the unanalyzed other-vehicle information, and acquires the first positioning performance. Then, the surrounding information analysis unit 7 outputs the acquired first positioning performance, which is the positioning performance of the other vehicle, to the positioning unit 3 and the positioning accuracy determination unit 4.

The positioning unit 3 acquires, as a parameter, GNSS information (equivalent to satellite information) from the GNSS signals received by the GNSS antenna 2, and determines a position of the own-vehicle (i.e., positioning) using the acquired GNSS information and the first positioning performance input from the surrounding information analysis unit 7.

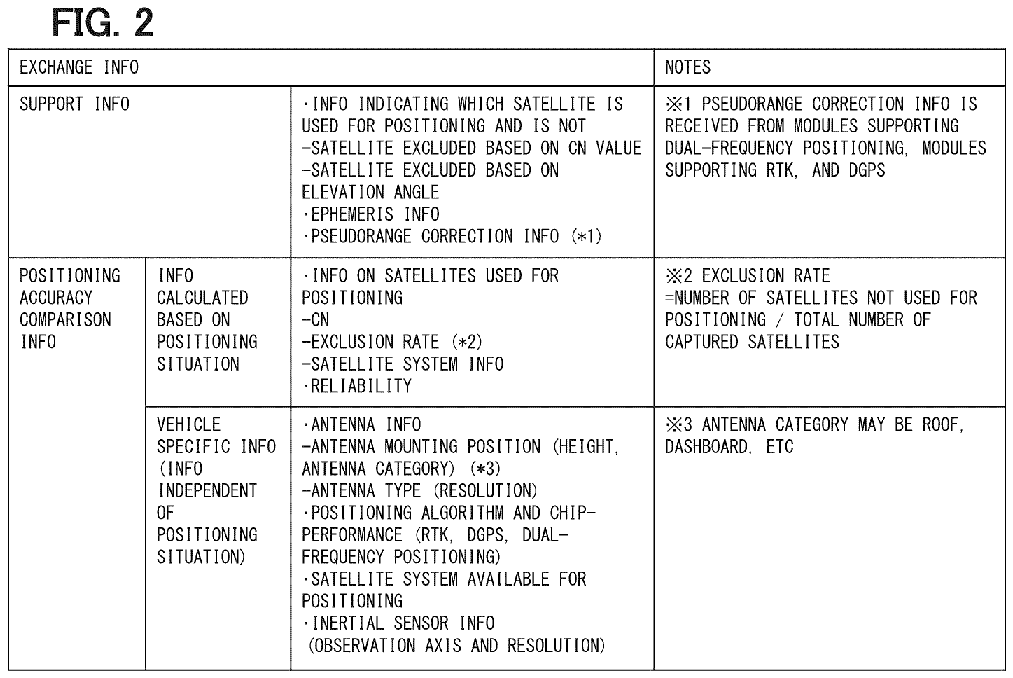

The positioning accuracy determination unit 4 determines accuracy of the positioning (positioning accuracy) of the own vehicle based on the positioning performance of the own vehicle and the first positioning performance input from the surrounding information analysis unit 7. The positioning performance of the own vehicle is also referred to as a second positioning performance. As shown in FIG. 2, the information used by the positioning accuracy determination unit 4 to determine the accuracy of the positioning includes information calculated from the positioning situation and vehicle specific information. The vehicle specific information is information that is not calculated based on the positioning situation and is independent of the positioning situation.

The information calculated from the positioning situation is, for example, information and reliability of satellites used for the positioning. The information about satellites used for positioning includes Carrier to Noise Density Ratio (CN), exclusion rate, and satellite system information. The exclusion rate is calculated by dividing the number of satellites not used for positioning by the total number of satellites captured. If the reliability is high, the evaluation of the information calculated from the positioning situation is high, and if the reliability is low, the evaluation of the information calculated from the positioning situation is low.

The vehicle specific information includes antenna information, positioning algorithms and chip performance, satellite systems that can be used for positioning, and inertial sensor information. The antenna information includes the antenna mounting position where the antenna is mounted and the type of the antenna. The antenna mounting position indicates the height and an antenna category. The antenna category may indicate a category such as a roof and an instrument panel. The positioning algorithms and chip performance are information on Real Time Kinematic (RTK), Differential Global Positioning System (DGPS), dual-frequency positioning, etc. The inertial sensor information is information on observation axes, resolution, and the like. When the positioning accuracy determination unit 4 has determined the accuracy of the positioning of the own vehicle, the positioning accuracy determination unit 4 outputs the determination result to the own-vehicle information generation unit 5.

The own-vehicle information generation unit 5 inputs the determination result from the positioning accuracy determination unit 4, generates own-vehicle information based on the input determination result, and stores the generated own-vehicle information in the own-vehicle information DB 8. The own-vehicle information transmitting unit 6b refers to the own-vehicle information DB 8 at predetermined intervals while, for example, the ignition switch is on, and the own-vehicle is ready to move. When the own-vehicle information DB 8 includes unsent own-vehicle information, the own-vehicle information transmitting unit 6b transmits the unsent own-vehicle information to the vehicle positioning system of the other vehicle. In this case, the own-vehicle information transmitting unit 6b may transmit, to the positioning system of the other vehicle, determination criteria of the positioning accuracy determination unit 4 for determining the accuracy of the positioning together with the own-vehicle information.

As shown in FIG. 2, the own-vehicle information and the other-vehicle information includes information indicating which satellite is used for positioning, information indicating which satellite is not used for positioning, ephemeris information, pseudorange correction information, etc. The pseudorange correction information is information received from a module supporting a dual-frequency positioning or a module supporting RTK or DGPS.

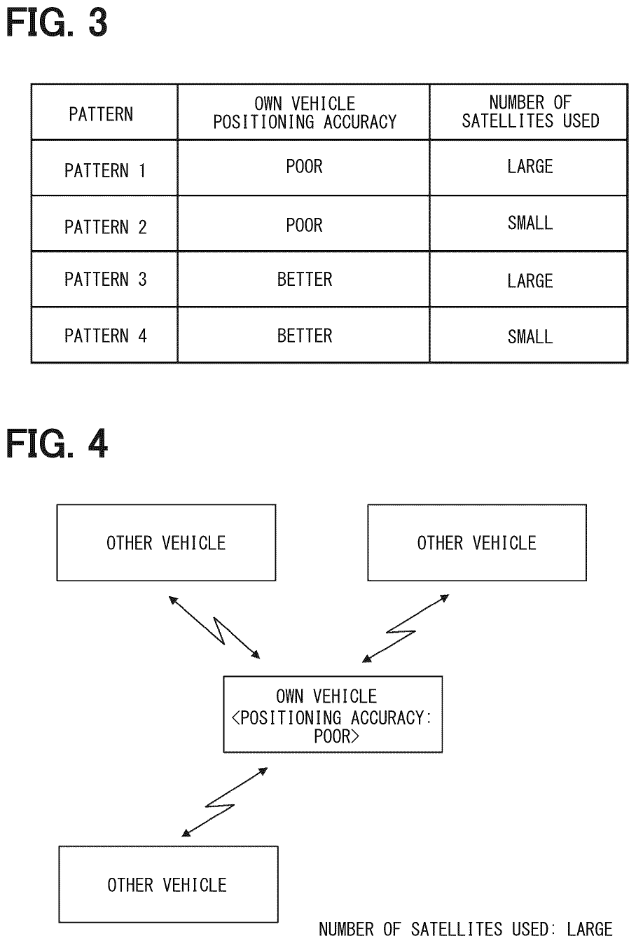

Here, the determination result of the positioning accuracy of the own vehicle by the positioning accuracy determination unit 4 will be explained with reference to FIGS. 3 to 7. The determination results of the positioning accuracy of the own vehicle by the positioning accuracy determination unit 4 include four patterns as shown in FIG. 3. Hereinafter, each pattern will be described. It should be noted that determination of whether the positioning accuracy of the own vehicle is better or poor is based on comparison with that of the other vehicle. The determination of whether the number of satellites used, which is the number of satellites used for positioning, is large or small is just a relative determination.

(1) The Case where the Positioning Accuracy of the Own Vehicle is Poor and the Number of Satellites Used is Large (See FIG. 4)

If the positioning accuracy of the own vehicle is poor and the number of satellites used is large, it is highly likely that many of the satellites used for positioning in the vehicle positioning system 1 are affected by multipath. In this case, the vehicle positioning system 1 of the own vehicle can eliminate multipath by reducing the satellites used for positioning, thereby improving the positioning accuracy of the own vehicle. The own-vehicle positioning system 1 of the own vehicle determines the satellites to be used for positioning by a majority decision, and transmits information about the satellites to be used for positioning to the vehicle positioning system of the other vehicle. The vehicle positioning system of the other vehicle can share the satellites used for positioning with the vehicle positioning system 1 of the own vehicle by receiving information about the satellites used for positioning from the vehicle positioning system 1 of the own vehicle.

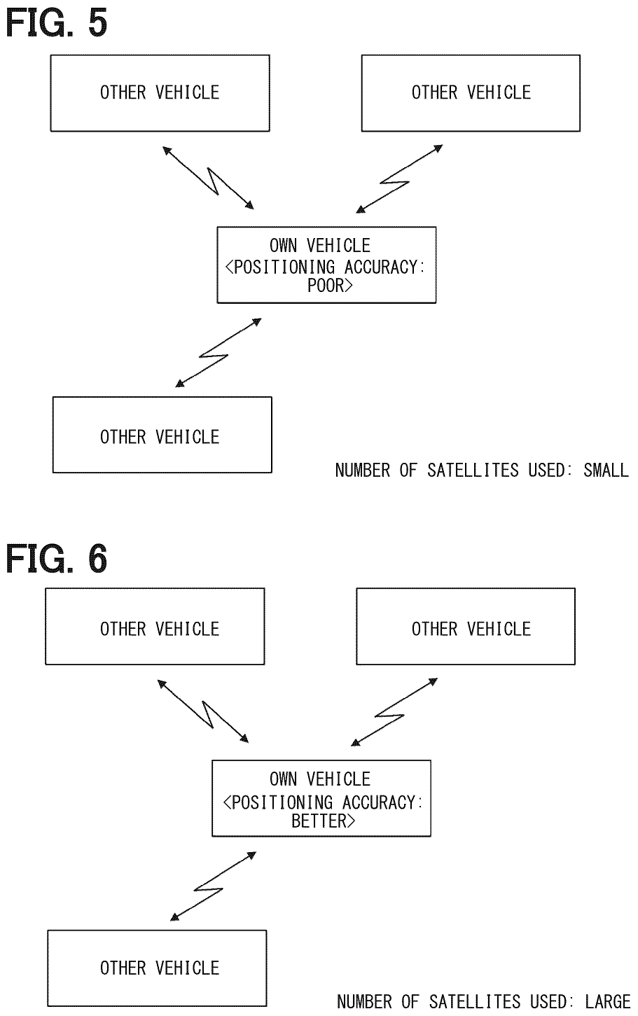

(2) The Case where the Positioning Accuracy of the Own Vehicle is Poor and the Number of Satellites Used is Small (See FIG. 5)

If the positioning accuracy of the own vehicle is poor, the number of satellites used is small, and the surrounding environment information of the own-vehicle is different from the surrounding environment information of other vehicles, it is highly likely that the parameters used in the vehicle positioning system 1 of the own-vehicle are inappropriate. In this case, the vehicle positioning system 1 of the own vehicle can dramatically change the parameters of the own vehicle to set the parameters appropriately, thereby improving the positioning accuracy of the own vehicle.

(3) The Case where the Positioning Accuracy of the Own Vehicle is Better and the Number of Satellites Used is Large (See FIG. 6)

When the positioning accuracy of the own vehicle is better and the number of satellites used is large, the vehicle positioning system 1 of the own vehicle is superior to those of other vehicles. In this case, the vehicle positioning system 1 of the own vehicle maintains the current status and transmits notification signals that indicate the own vehicle maintains the current status to the vehicle positioning systems of other vehicles.

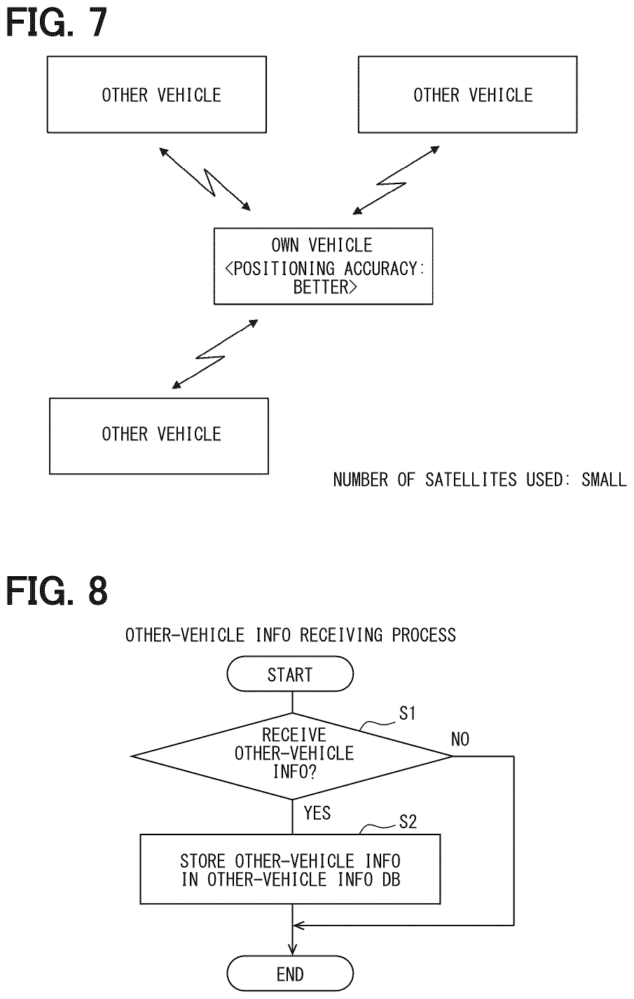

### (4) When the Positioning Accuracy of the Own Vehicle is Better and the Number of Satellites Used is Small (See FIG. 7)

If the positioning accuracy of the own vehicle is better and the number of the satellites used is small, it is highly likely that many of the satellites used for positioning in the vehicle positioning systems of other vehicles are affected by multipath. In this case, the vehicle positioning system 1 of the own vehicle can share the satellites used for positioning with the vehicle positioning systems of other vehicles by transmitting information about the excluded satellites to the vehicle positioning systems of the other vehicles. The vehicle positioning systems of the other vehicles can eliminate the multipath effects by reducing the satellites used for positioning, thereby improving the positioning accuracy of the other vehicles.

Next, the process of the above configuration will be described with reference to FIGS. 8 to 10. The vehicle positioning system 1 performs an other-vehicle information receiving process, a positioning process, and an own-vehicle information transmitting process. Each process will be described below.

### (1) Other-Vehicle Information Receiving Process (See FIG. 8)

The vehicle positioning system 1 performs an other-vehicle information receiving process at predetermined intervals. When a start condition of the other-vehicle information receiving process for each predetermined interval is satisfied, the vehicle positioning system 1 starts the other-vehicle information receiving process, and determines whether other-vehicle information is received from the vehicle positioning system of another vehicle in a period from the end of the previous other-vehicle information receiving process to the start of this other-vehicle information receiving process (S1). When the vehicle positioning system 1 determines that other-vehicle information is not received (S1: NO), the vehicle positioning system 1 ends the other-vehicle information receiving process and waits until the start condition of the next other-vehicle information receiving process is satisfied. When the vehicle positioning system 1 determines that the other-vehicle information has been received (S1: YES), the vehicle positioning system 1 stores the received other-vehicle information in the other-vehicle information DB 9 (S2), and ends the other-vehicle information receiving process. Then, the vehicle positioning system 1 waits until the start condition of the next other-vehicle information receiving process is satisfied.

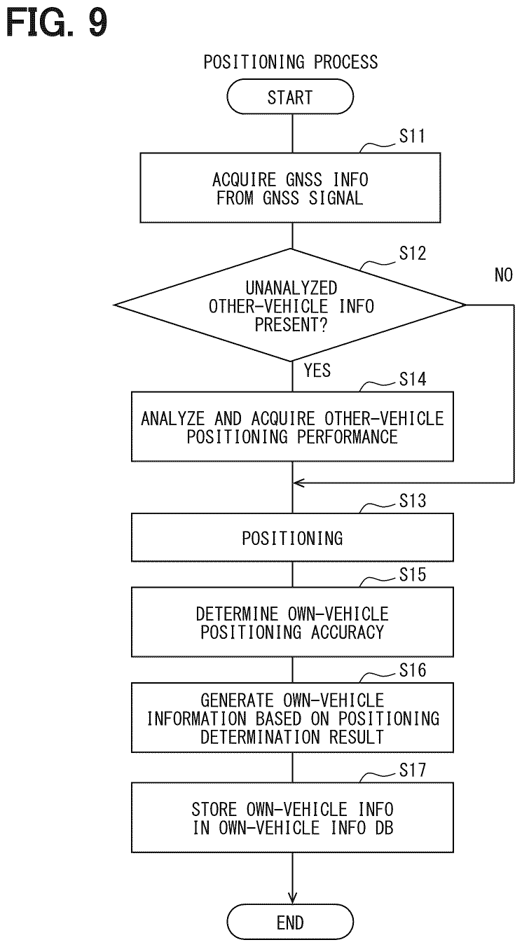

### (2) Positioning Process (See FIG. 9)

The vehicle positioning system 1 performs the positioning process at predetermined intervals. The vehicle positioning system 1 starts the positioning process and acquires, as a parameter, GNSS information from GNSS signals received by the GNSS antenna 2 when a start condition of the positioning process for each predetermined interval is satisfied (S11). The vehicle positioning system 1 refers to the other-vehicle information DB 9, and determines whether unanalyzed other-vehicle information is stored in the other-vehicle information DB 9 (S12). When the vehicle positioning system 1 determines that unanalyzed other-vehicle information is not stored in the other-vehicle information DB 9 (S12: NO), the vehicle positioning system 1 performs positioning using the GNSS information (S13).

When the vehicle positioning system 1 determines that unanalyzed other-vehicle information is stored in the other vehicle information DB 9 (S12: YES), the vehicle positioning system 1 analyzes the unanalyzed other-vehicle information, acquires the first positioning performance of the other vehicle (S14), and performs positioning based on the GNSS information and the first positioning performance of the other vehicle (S13). In this case, the vehicle positioning system 1 compares the second positioning performance of the own vehicle with the first positioning performance of the other vehicle. If the vehicle positioning system 1 has determined that the second positioning performance is superior to the first positioning performance, the vehicle positioning system 1 performs positioning without using the other-vehicle information. If the vehicle positioning system 1 has determined that the first positioning performance is superior to the second positioning performance, the vehicle positioning system 1 performs positioning using the GNSS information and the other-vehicle information.

After performing the positioning, the vehicle positioning system 1 determines the positioning accuracy of the own vehicle (S15) and generates own-vehicle information based on the determination results of the positioning accuracy (S16). In this case, the vehicle positioning system 1 generates own-vehicle information that can identify which of the positioning performance is superior, the own vehicle and the other vehicle. That is, the vehicle positioning system 1 generates own-vehicle information indicating that the antenna mounting position of the own-vehicle is superior to that of the other vehicle when the own vehicle is superior to the other vehicle in the positioning performance relating to the antenna mounting position. The vehicle positioning system 1 generates own-vehicle information indicating that the positioning algorithm of the own vehicle is superior to that of the other vehicle when the own vehicle is superior to the other vehicle in the positioning performance relating to the positioning algorithm. After the vehicle positioning system 1 generates the own-vehicle information, the vehicle positioning system 1 stores the generated own-vehicle information in the own-vehicle information DB 8 (S17) and ends the positioning process.

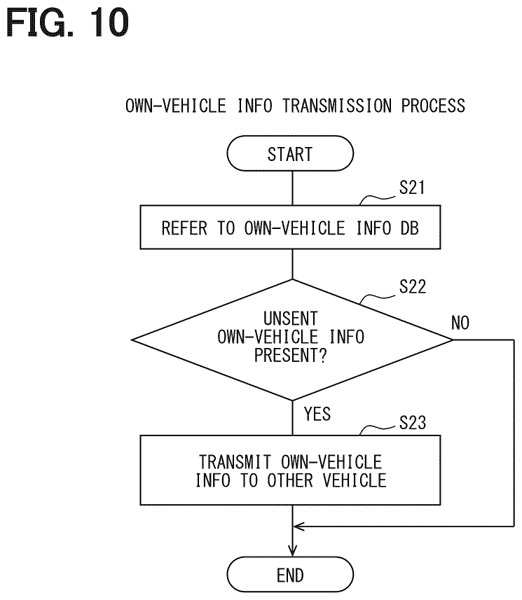

### (3) Own-Vehicle Information Transmitting Process (See FIG. 10)

The vehicle positioning system 1 performs the own-vehicle information transmitting process at predetermined intervals. When a start condition of the own-vehicle information transmitting process for each predetermined interval is satisfied, the vehicle positioning system 1 starts the own-vehicle information transmitting process, refers to the own-vehicle information DB 8 (S21), and determines whether unsent own-vehicle information, which is own-vehicle information that has not yet transmitted, is stored in the own-vehicle information DB 8 (S22). When the vehicle positioning system 1 determines that unsent own-vehicle information is not stored in the own-vehicle information DB 8 (S22: NO), the vehicle positioning system 1 ends the own-vehicle information transmitting process and waits until the start condition of the next own-vehicle information transmitting process is satisfied. When the vehicle positioning system 1 determines that unsent own-vehicle information is stored in the own-vehicle information DB 8 (S22: YES), the vehicle positioning system 1 causes the own-vehicle information transmitting unit 6b to transmit the unsent own-vehicle information to the vehicle positioning system of another vehicle (S23), and ends the own-vehicle information transmitting process. Then, the vehicle positioning system 1 waits until the start condition for the next own-vehicle information transmitting process is satisfied.

As described above, according to the embodiment, the following operational effects can be obtained.

The vehicle positioning system 1 is configured to analyze the other-vehicle information transmitted by another vehicle around the own vehicle, acquire the positioning performance of the other vehicle, and perform positioning based on GNSS information acquired by the own vehicle and the first positioning performance of the other vehicle. The vehicle positioning system of the present disclosure is further configured to determine a positioning accuracy of the second vehicle based on the second positioning performance and the first positioning performance, generate second-vehicle information based on the determination result, and transmit the generated second-vehicle information to the first vehicle. Thus, the second vehicle information, which is effective for improving the first positioning performance, is provided to the first vehicle when the first positioning performance is inferior to the second positioning performance, thereby improving the positioning accuracy of the entire system including the first vehicle.

The vehicle positioning system 1 is configured to compare the second positioning performance of the own vehicle and the first positioning performance of the other vehicle by comparing information dependent on positioning situation between the first vehicle and the second vehicle. Thus, the information dependent on the positioning situation can be reflected in the positioning accuracy of the own vehicle.

The information dependent on the positioning situation includes information about satellites used for positioning and reliability of the satellites used for positioning. Thus, the information and reliability of satellites used for positioning can be reflected in the positioning accuracy of the own vehicle.

The vehicle positioning system 1 is configured to compare the positioning performance of the own-vehicle and the positioning situation of the second vehicle by comparing information independent of the positioning situation between the first vehicle and the second vehicle. Thus, the information independent of the positioning situation can be reflected in the positioning accuracy of the own vehicle.

The information independent of the positioning situation includes antenna information, performance of positioning algorithms and chips, satellite systems available for positioning, and inertial sensor information. Thus, the antenna information, performance of positioning algorithms and chips, satellite systems available for positioning, and inertial sensor information can be reflected in the positioning accuracy of the own vehicle.

The vehicle positioning system 1 is configured to transmit information indicating which satellite is used for positioning, information indicating which satellite is not used for positioning, ephemeris information, and pseudorange correction information to the other vehicle. Thus, information indicating which satellite is used for positioning, information indicating which satellite is not used for positioning, ephemeris information, and pseudorange correction information are transmitted from the own vehicle to the other vehicle.

Although the present disclosure has been described in accordance with the embodiments, it is understood that the present disclosure is not limited to the embodiments and structures described above. The present disclosure encompasses various modifications and variations within the scope of equivalents. Additionally, various combinations and configurations, as well as other combinations and configurations including more, less, or only a single element, are within the scope and spirit of the present disclosure.

The control units and methods described in the present disclosure may be implemented by a special purpose computer provided by configuring a memory and a processor programmed to execute one or more functions embodied by a computer program. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer program may also be stored on a computer readable and non-transitory tangible recording medium as instructions executed by a computer.

1. A vehicle positioning system comprising:
a first-vehicle information receiving unit configured to receive first-vehicle information transmitted by a first vehicle around a second vehicle:
a surrounding information analysis unit configured to analyze the first-vehicle information to acquire a first positioning performance of the first vehicle;
a positioning unit configured to perform positioning of the second vehicle based on satellite information acquired by the second vehicle and the first positioning performance;
a positioning accuracy determination unit configured to determine accuracy of the positioning of the second vehicle based on the first positioning performance and a second positioning performance of the second vehicle;
a second-vehicle information generation unit configured to generate second-vehicle information based on a determination result by the positioning accuracy determination unit, the second-vehicle information including at least one of information indicating which satellite is used for the positioning of the second vehicle, information indicating which satellite is not used for the positioning of the second vehicle, ephemeris information, or pseudorange correction information; and
a second-vehicle information transmitting unit configured to transmit the second-vehicle information to the first vehicle.

2. The vehicle positioning system according to claim 1, wherein
the positioning accuracy determination unit is configured to compare the first positioning performance with the second positioning performance by comparing information dependent on a positioning situation between the first vehicle and the second vehicle.

3. The vehicle positioning system according to claim 2, wherein
the information dependent on the positioning situation is at least one of information of a satellite used for the positioning or a reliability of the satellite used for the positioning.

4. The vehicle positioning system according to claim 1, wherein
the positioning accuracy determination unit is configured to compare the first positioning performance with the second positioning performance by comparing information independent of a positioning situation between the first vehicle and the second vehicle.

5. The vehicle positioning system according to claim 4, wherein
the information independent of the positioning situation is at least one of antenna information, performance of positioning algorithm or a chip, a satellite system available for the positioning, or inertial sensor information.

6. A non-transitory computer readable storage medium comprising a second-vehicle information provision program configured to cause a vehicle positioning system to:
receive first-vehicle information transmitted by a first vehicle around a second vehicle;
analyze the first-vehicle information to acquire a first positioning performance of the first vehicle;
perform positioning of the second vehicle based on satellite information acquired by the second vehicle and the first positioning performance;
determine accuracy of the positioning of the second vehicle based on the first positioning performance and a second positioning performance of the second vehicle;
generate second-vehicle information based on a determination result of the accuracy, the second-vehicle information including at least one of information indicating which satellite is used for the positioning of the second vehicle, information indicating which satellite is not used for the positioning of the second vehicle, ephemeris information, or pseudorange correction information; and
transmit the second-vehicle information to the first vehicle.

7. A vehicle positioning system comprising at least one of (i) a circuit and (ii) a processor having a memory storing computer program code, wherein the at least one of the circuit and the processor having the memory is configured to cause the vehicle positioning system to:
receive first-vehicle information transmitted by a first vehicle around a second vehicle;
analyze the first-vehicle information to acquire a first positioning performance of the first vehicle;
perform positioning of the second vehicle based on satellite information acquired by the second vehicle and the first positioning performance;
determine accuracy of the positioning of the second vehicle based on the first positioning performance and a second positioning performance of the second vehicle;
generate second-vehicle information based on a determination result of the accuracy, the second-vehicle information including at least one of information indicating which satellite is used for the positioning of the second vehicle, information indicating which satellite is not used for the positioning of the second vehicle, ephemeris information, or pseudorange correction information; and
transmit the second-vehicle information to the first vehicle.

8. The vehicle positioning system according to claim 7, wherein
the at least one of the circuit and the processor having the memory is further configured to cause the vehicle positioning system to:
compare the first positioning performance and the second positioning performance;
perform the positioning of the second vehicle using the satellite information and the first-vehicle information when the first positioning performance is superior to the second positioning performance; and
perform the positioning of the second vehicle based on the satellite information without using the first-vehicle information when the first positioning performance is inferior to the second positioning performance.
